(19) United States
(12) Patent Application Publication
(10) Pub. No.: US 2015/0345064 A1
(43) Pub. Date: Dec. 3, 2015

(54) COIN WASHING MACHINE WITH CHARGING FUNCTION

(71) Applicant: Tai-Lang Chiu, Taipei City (TW)

(72) Inventor: Tai-Lang Chiu, Taipei City (TW)

(21) Appl. No.: 14/722,120

(22) Filed: May 26, 2015

(30) Foreign Application Priority Data
May 27, 2014 (TW) 103118451

(51) Int. Cl. D06F 33/02; H02J 7/00

(52) U.S. Cl. CPC D06F 33/02; H02J 7/0042; H02J 7/0052; H02J 2007/0062

(57) ABSTRACT

A coin washing machine includes a laundry module, a washing machine door, a controller, a door-closing detection unit, and a power converter. The laundry module is for washing clothes. The washing machine door is arranged at a position corresponding to the laundry module. The controller is coupled to the laundry module via a power supply path, for controlling an external AC voltage source to supply power to the laundry module during a power supply period. The door-closing detection unit is arranged on the power supply path, for enabling conduction of the power supply path when the washing machine door is closed. The power converter is coupled between the laundry module and the door-closing detection unit, for generating a DC voltage according to the external AC voltage source when the conduction of the power supply path is enabled during the power supply period, in order to charge an external electronic device.

### BACKGROUND OF THE INVENTION

1. Field of the Invention

The present invention relates to a coin washing machine, and more particularly, to a coin washing machine with a charging function for an external electronic device.

2. Description of the Prior Art

With increased requirement, coin laundries become more and more popular in metropolitan areas. Current coin laundries may provide coin washing machines and coin dryers. When a user inputs a sufficient amount of coins, the user can use the coin washing machine for washing clothes or use the coin dryer for drying clothes. However, it takes a certain length of time when the coin washing machine performs a laundry operation, and the user may uses a smartphone during time waiting for the laundry operation to finish. When the smartphone is in a low battery status due to frequent usage, the user may have problems to answer incoming calls or make outgoing calls. But if the coin laundry provides a power socket to the user for charging the smartphone, non-consumers may also enter the coin laundry to use power provided by the power socket, so as to increase operating cost of the coin laundry.

### SUMMARY OF THE INVENTION

The present invention provides a coin washing machine with a charging function, in order to solve problems of the prior art.

The coin washing machine of the present invention comprises a laundry module, a washing machine door, a controller, a door-closing detection unit, and a power converter. The laundry module is configured to wash clothes. The washing machine door is arranged at a position corresponding to the laundry module. The controller is coupled to the laundry module via a power supply path, for controlling an external AC voltage source to supply power to the laundry module during a power supply period corresponding to an input amount of coins. The door-closing detection unit is arranged on the power supply path, for enabling conduction of the power supply path when the washing machine door is closed. The power converter is coupled between the laundry module and the door-closing detection unit, for generating a DC voltage according to the external AC voltage source when the conduction of the power supply path is enabled during the power supply period, in order to charge an external electronic device.

According to an embodiment of the present invention, the coin washing machine further comprises a power connector coupled to the power converter, wherein the power converter is configured to charge the external electronic device through the power connector.

According to an embodiment of the present invention, the power connector is a universal serial bus (USB) connector.

According to an embodiment of the present invention, the door closing detection unit comprises an electromagnetic switch, configured to be activated when the washing machine door is closed, in order to enable the conduction of the power supply path.

According to an embodiment of the present invention, when the electromagnetic switch is activated, the washing machine door is locked.

In contrast to the prior art, the coin washing machine of the present invention has a charging function, which allows a user to charge a smartphone (or other electronic device) by using the power converter when the user input a sufficient amount of coins to perform laundry operation, so as to prevent the smartphone from being in a low battery status due to frequent usage during time waiting for the laundry operation to finish. Thus, it can increase convenience when the user using the coin washing machine of the present invention. Moreover, the coin washing machine of the present invention does not provide the charging function out of the power supply period, so as to prevent power from being used by non-consumers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a coin washing machine with a charging function of the present invention.

FIG. 2 is a diagram showing operation of a door closing detection unit of the present invention when a washing machine door is opened.

FIG. 3 is a diagram showing operation of the door closing detection unit of the present invention when the washing machine door is closed.

### DETAILED DESCRIPTION

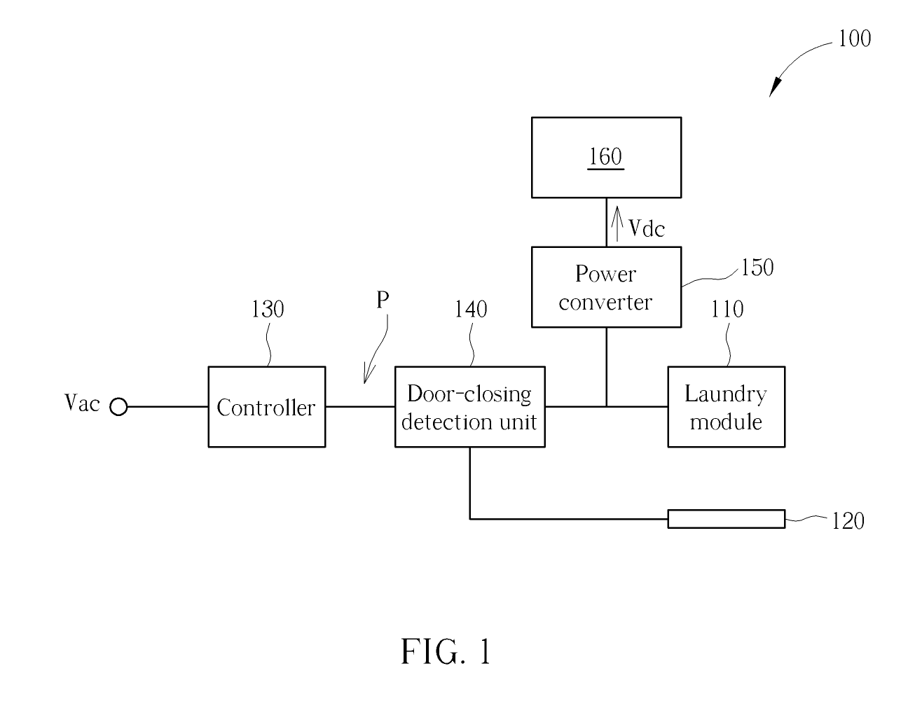

Please refer to FIG. 1. FIG. 1 is a functional block diagram of a coin washing machine with a charging function of the present invention. As shown in FIG. 1, the coin washing machine 100 with the charging function of the present invention comprises a laundry module 110, a washing machine door 120, a controller 130, a door-closing detection unit 140, and a power converter 150. The laundry module 110 is configured to wash clothes. The washing machine door 120 is arranged at a position corresponding to the laundry module 110. When the washing machine door 120 is opened, a user can place clothes into the laundry module 110; and when the washing machine door 120 is closed, an enclosed space is formed by the washing machine door 120 and the laundry module 110 for performing a laundry operation. The controller 130 is coupled to the laundry module 110 via a power supply path P. The controller 130 is configured to control an external AC voltage source Vac to supply power to the laundry module 110 during a power supply period corresponding to an input amount of coins. For example, when the amount of coins inputted by the user reaches a predetermined amount, the controller determines a length of the power supply period, and controls the external AC voltage source Vac to supply power to the laundry module 110 via the power supply path P during the power supply period, in order to activate the laundry module 110 to perform the laundry operation during the power supply period. The door-closing detection unit 140 is arranged on the power supply path P, for enabling conduction of the power supply path P when the washing machine door 120 is closed, in order to prevent the laundry module 110 from performing the laundry operation when the washing machine door 120 is not closed. The power converter 150 is coupled between the laundry module 110 and the door-closing detection unit 140, for generating a DC voltage Vdc according to the external AC voltage source Vac when the conduction of the power supply path P is enabled during the power supply period, in order to charge an external electronic device.

In addition, the coin washing machine 100 of the present invention can further comprises a power connector 160 coupled to the power converter 150. The power converter 150 can charge the external electronic device through the power connector 160. For example, the power connector can be a universal serial bus (USB) connector, such as a mini USB connector or a micro USB connector, such that the power connector 160 can charge a smartphone or other electronic device through the power connector 160.

According to the above arrangement, when the user input a sufficient amount of coins to perform the laundry operation, the user can also use the power converter 150 to charge the smartphone during the power supply period, in order to prevent the smartphone from being in a low battery status due to frequent usage during time waiting for the laundry operation to finish. And when the coin washing machine 100 finishes the laundry operation, the controller 130 controls the external AC voltage source Vac to stop supplying power to the laundry module 110, such that the power converter is not able to generate the DC voltage Vdc thereafter, in order to prevent power from being used by non-consumers when the coin washing machine 100 is not performing the laundry operation.

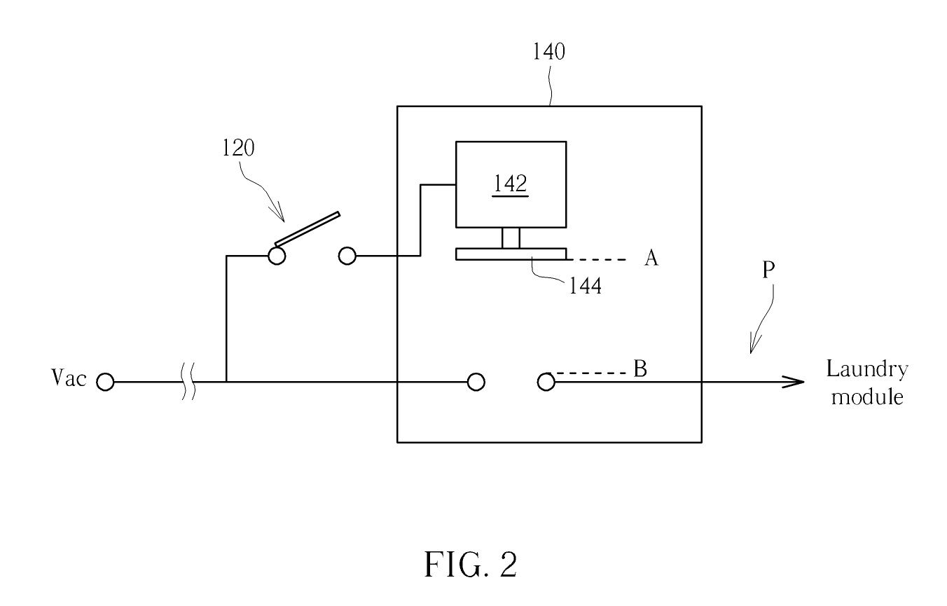

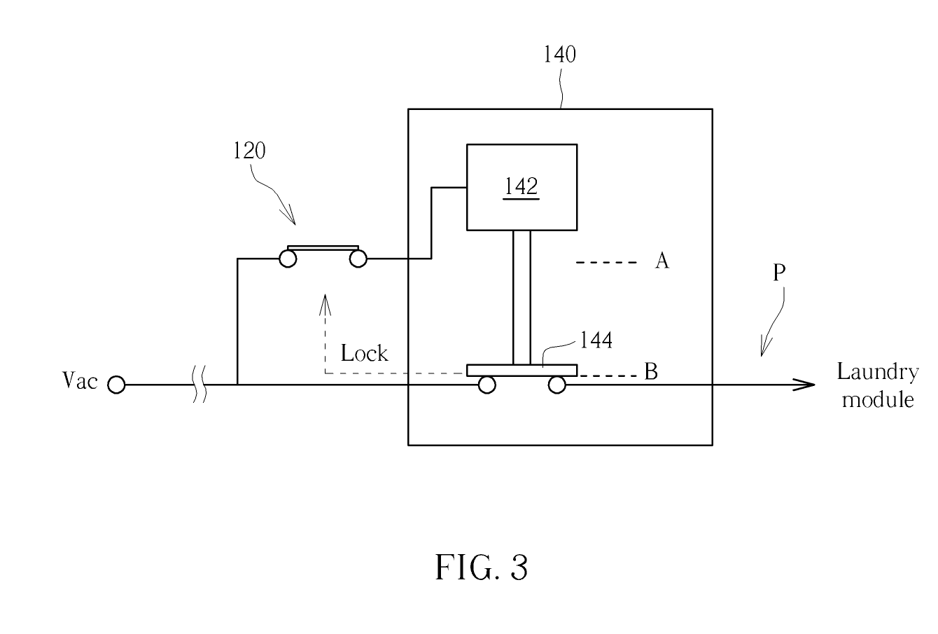

Please refer to FIG. 2 and FIG. 3, and refer to FIG. 1 as well. FIG. 2 is a diagram showing operation of a door closing detection unit of the present invention when a washing machine door is opened. FIG. 3 is a diagram showing operation of the door closing detection unit of the present invention when the washing machine door is closed. As shown in figures, the door closing detection unit 140 comprises an electromagnetic switch 142. During the power supply period, when the washing machine door 120 is opened, the electromagnetic switch 142 is not activated, and a contact terminal 144 of the electromagnetic switch 142 is located at a first position A, thus conduction of the power supply path P between the controller 130 and the laundry module 110 is disabled, such that the laundry module 110 is not powered; and when the washing machine door 120 is closed, the electromagnetic switch 142 is activated, and the contact terminal 144 of the electromagnetic switch 142 is located at a second position B, thus the conduction of the power supply path P between the controller 130 and the laundry module 110 is enabled, such that the laundry module 110 is powered to perform the laundry operation during the power supply period.

On the other hand, when the electromagnetic switch 142 is activated to move the contact terminal 144 to be located at the second position B, the electromagnetic switch 142 may lock the washing machine door 120 mechanically, for preventing the washing machine door 120 from being opened when the laundry module 110 performs the laundry operation.

In contrast to the prior art, the coin washing machine of the present invention has a charging function, which allows a user to charge a smartphone (or other electronic device) by using the power converter when the user input a sufficient amount of coins to perform laundry operation, so as to prevent the smartphone from being in a low battery status due to frequent usage during time waiting for the laundry operation to finish. Thus, it can increase convenience when the user using the coin washing machine of the present invention. Moreover, the coin washing machine of the present invention does not provide the charging function out of the power supply period, so as to prevent power from being used by non-consumers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coin washing machine with a charging function, comprising:
a laundry module, configured to wash clothes;
a washing machine door, arranged at a position corresponding to the laundry module;
a controller, coupled to the laundry module via a power supply path, for controlling an external AC voltage source to supply power to the laundry module during a power supply period corresponding to an input amount of coins;
a door closing detection unit, arranged on the power supply path, for enabling conduction of the power supply path when the washing machine door is closed; and
a power converter, coupled between the laundry module and the door-closing detection unit, for generating a DC voltage according to the AC voltage source when the conduction of the power supply path is enabled during the power supply period, in order to charge an external electronic device.

2. The coin washing machine of claim 1 further comprising a power connector coupled to the power converter, wherein the power converter is configured to charge the external electronic device through the power connector.

3. The coin washing machine of claim 2, wherein the power connector is a universal serial bus (USB) connector.

4. The coin washing machine of claim 1, wherein the door closing detection unit comprises an electromagnetic switch, configured to be activated when the washing machine door is closed, in order to enable the conduction of the power supply path.

5. The coin washing machine of claim 4, wherein when the electromagnetic switch is activated, the washing machine door is locked.
